(19) United States
(12) Patent Application Publication
(10) Pub. No.: US 2024/0198419 A1
(43) Pub. Date: Jun. 20, 2024

(54) APPARATUS AND METHODS FOR INORGANIC ELECTROLYTE SYNTHESIS

(71) Applicant: Blue Current, Inc., Hayward, CA (US)

(72) Inventors: Benjamin Rupert, Hayward, CA (US); Josephine Pedersen, Hayward, CA (US)

(21) Appl. No.: 18/556,807

(22) PCT Filed: Apr. 22, 2022
(86) PCT No.: PCT/US2022/026011

§ 371 Date: Oct. 23, 2023

Related U.S. Application Data
(60) Provisional application No. 63/201,336, filed on Apr. 23, 2021.

(51) Int. Cl. B22F 1/142; B22F 9/04; B22F 9/20

(52) U.S. Cl. CPC B22F 1/142; B22F 9/20; B22F 2009/045; B22F 2202/11; B22F 2301/40

(57) ABSTRACT

Methods for millling particles include exposing particles to microwave energy during milling. The methods reduce or eliminate the need for pre- and post-processing of reagents and products while minimizing waste associated with the slow kinetics of heat transfer in traditional resistive heating furnaces. Method of synthesizing particles include providing precursor particles, microwave susceptor media, and milling media in a reaction vessel and simultaneously rotating the reaction vessel while exposing the reaction vessel to microwaves. Apparatus for milling particles include a microwave housing defining a microwave enclosure; a microwave generator configured to generate and direct microwaves to the microwave enclosure; and a rotation shaft within the microwave enclosure, the rotation shaft connected or configured to be connected to a motor for rotation, wherein the rotation shaft is configured to be rotatably coupled, within the microwave enclosure, to a processing vessel.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Synthesis, annealing, and particle size reduction of inorganic electrolytes are time and labor intensive and can be difficult to scale up. Synthesis pathways for inorganic electrolytes such as lithium-ion conducting argyrodites use multiple operations and pieces of equipment for initial synthesis and post-synthesis particle size control to produce a useful product.

### SUMMARY

One aspect of the disclosure relates to an apparatus including a microwave housing defining a microwave enclosure; a microwave generator configured to generate and direct microwaves to the microwave enclosure; and a rotation shaft within the microwave enclosure, the rotation shaft connected or configured to be connected to a motor for rotation, wherein the rotation shaft is configured to be rotatably coupled, within the microwave enclosure, to a processing vessel.

In some embodiments, the apparatus further includes a processing vessel within the microwave enclosure, the processing vessel rotatably coupled to the rotation shaft. In some embodiments, the apparatus further includes milling media within the processing vessel. In some embodiments, the processing vessel is attached to an end of the rotation shaft. In some embodiments, the milling media is a microwave susceptor. In some embodiments, the milling media is microwave transparent. In some embodiments, the apparatus further includes microwave susceptor media. In some embodiments, the apparatus further includes a second rotation shaft. In some such embodiments, the second rotation shaft is not actively powered. In some embodiments, the rotation shaft and the second rotation shaft are configured to support the processing vessel within the microwave enclosure. In some embodiments, the processing vessel includes a cylindrical body. In some embodiments, the processing vessel includes a body that is microwave transparent. In some embodiments, the body is glass. In some embodiments, processing vessel includes a body that is a microwave susceptor. In some embodiments, the processing vessel is sealed. In some embodiments, the processing vessel is open to the microwave enclosure.

Another aspect of the disclosure relates to a method including providing a processing vessel containing particles to be processed and milling media; and simultaneously a) moving the processing vessel to cause interactions between the particles and the milling media to thereby reduce the size of the particles and b) exposing the processing vessel to microwave radiation.

In some embodiments, the milling media is a microwave susceptor. In some embodiments, the milling media is microwave transparent. In some such embodiments, the processing vessel further contains microwave susceptor media. In some embodiments, the particles to be processed include argyrodite precursors.

Another aspect of the disclosure relates to a method including providing argyrodite precursor particles, microwave susceptor media, and milling media in a reaction vessel; simultaneously rotating the reaction vessel while exposing the reaction vessel to microwaves to thereby heat the microwave susceptor media and reduce the size of the argyrodite precursor particles; heating the argyrodite precursor particles by contact with the microwave susceptor media; reacting the argyrodite precursor particles to form argyrodite particles; and reducing the size of the argyrodite particles.

In some embodiments, the argyrodite precursor particles include Li_{X}, Li₂S, and P₂S₅, wherein X is a halogen. In some embodiments, the argyrodite precursor particles further include elemental sulfur. In some embodiments, the microwave susceptor media are the milling media. In some embodiments, the microwave susceptor media and the milling media are different media. In some embodiments, the method further includes reducing microwave power as more argyrodite particles are formed. In some embodiments, the method includes ending the microwave exposure and continuing to rotate the reaction vessel to further reduce argyrodite particle size.

Another aspect of the disclosure relates to a method including providing precursor particles of a sulfide-containing solid electrolyte, microwave susceptor media, and milling media in a reaction vessel; simultaneously rotating the reaction vessel while exposing the reaction vessel to microwaves to thereby heat the microwave susceptor media and reduce the size of the precursor particles; heating the precursor particles by contact with the microwave susceptor media; and reacting the precursor particles to form sulfide-containing solid electrolytes particles. In some embodiments, the methods further include reducing the size of the particles.

In some embodiments, the particles are argyrodite particles. In some embodiments, the particles are sulfide glass particles.

These another aspects of the disclosure are described further below with reference to the drawings.

### BRIEF DESCRIPTION OF THE DRAWINGS

FIG. 1 shows the crystal structure of an example argyrodite, Li₆PS₅Cl.

FIGS. 2, 3A, and 3B show example apparatuses for implementing the methods described herein.

### DETAILED DESCRIPTION

Described herein are methods and apparatus for microwave milling of materials. In some embodiments, fast and efficient methods of producing argyrodite-type lithium ion solid electrolytes and other materials, including other inorganic ionic conductors, are described. Implementations of the methods involve exposing the reactant particles to microwave energy while simultaneously milling them. Also described are methods of annealing by simultaneous microwave exposure and milling. In some embodiments, a chemically inert and microwave susceptible media is used for heat transfer. The same or other media may be used for milling.

In some embodiments, the apparatus includes a housing defining a microwave enclosure and a rotation shaft within the enclosure. The rotation shaft is actively powered, and is rotatably coupled (or is configured to be rotatably coupled) to a processing vessel, such that the processing vessel rotates as the rotation shaft rotates. The processing vessel can contain milling media and reagents or other particles to be processed. In some embodiments, it contains microwave susceptor media.

One or more of the following advantages may be realized. In some embodiments, the methods allow omitting mixing and grinding precursor particles before the heating in a synthesis reaction. In some embodiments, a synthesis results in a uniform distribution of elements (e.g., Li, S, Cl, P) throughout the synthesized product. In some embodiments, the product after reaction is a non-monolithic, powdered product. In some embodiments, the synthesis is energy efficient and scalable to high volume manufacturing. In some embodiments, the reaction or other processing is solvent-free and suspension-free, eliminating organic residue from a solvent or suspension medium. In some embodiments, the use of a microwave susceptible media during processing facilitates efficient heat transfer. These and other aspects are described further below.

The microwave milling methods and apparatus may be implemented to synthesize various products from particle reagents. In some embodiments, argyrodites are synthesized. A description of argyrodites and their synthesis using the microwave milling methods of the present disclosure follows. The microwave milling methods may also be used for annealing.

In some such cases, a phase change may be induced. For example, annealing may be used to make an amorphous material crystalline or semicrystalline. Annealing can also increase grain size. Annealing may be performed as part of a synthesis or as an independent process.

### Argyrodites

The mineral Argyrodite, Ag₈GeS₆, can be thought of as a co-crystal of Ag₄GeS₄ and two equivalents of Ag₂S. Substitutions in both cations and anions can be made in this crystal while still retaining the same overall spatial arrangement of the various ions. In Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original Ag₈GeS₆, some cation sites are vacant. These structural analogs of the original Argyrodite mineral are referred to as argyrodites as well.

Both Ag₈GeS₆ and Li₇PS₆ are orthorhombic crystals at room temperature, while at elevated temperatures phase transitions to cubic space groups occur. Making the further substitution of one equivalent of LiCl for one Li₂S yields the material Li₆PS₅Cl, which still retains the argyrodite structure but undergoes the orthorhombic to cubic phase transition below room temperature and has a significantly higher lithium-ion conductivity. Because the overall arrangement of cations and anions remains the same in this material as well, it is also commonly referred to as an argyrodite. Further substitutions which also retain this overall structure may therefore also be referred to as argyrodites. Alkali metal argyrodites more generally are any of the class of conductive crystals with alkali metals occupying Ag+ sites in the original Argyrodite structure, and which retain the spatial arrangement of the anions found in the original mineral.

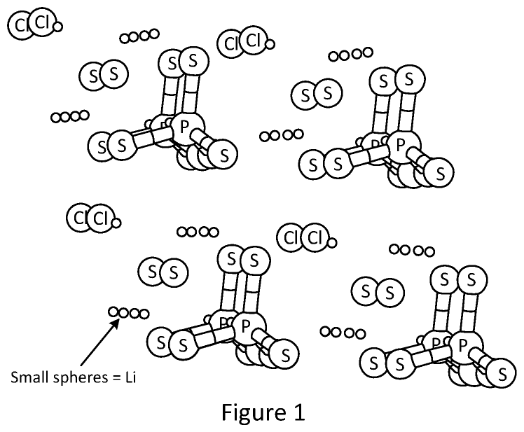

In one example, a lithium-containing example of this mineral type, Li₇PS₆, PS₄³⁻ ions reside on the crystallographic location occupied by GeS₄⁴⁻ in the original mineral, while S²⁻ ions retain their original positions and Li⁺ ions take the positions of the original Ag⁺ ions. As there are fewer cations in Li₇PS₆ compared to the original Ag₈GeS₆, some cation sites are vacant. As indicated above, making the further substitution of one equivalent of LiCl for one Li₂S yields the material Li₆PS₅Cl, which still retains the argyrodite structure. FIG. 1 shows a cubic argyrodite Li₆PS₅Cl. In the example of FIG. 1, Li⁺ occupies the Ag⁺ sites in the Argyrodite mineral, PS₄³⁻ occupies the GeS₄⁴⁻ sites in the original, and a one to one ratio of S²⁻ and Cl⁻ occupy the two original S²⁻ sites.

There are various manners in which substitutions may be made that retain the overall argyrodite structure. For example, the original mineral has two equivalents of S²⁻, which can be substituted with chalcogen ions such as O²⁻, Se²⁻ and Te²⁻. A significant fraction of the of S²⁻ can be substituted with halogens. For example, up to about 1.6 of the two equivalents of S²⁻ can be substituted with Cl⁻, Br⁻, and I⁻¹, with the exact amount depending on other ions in the system. While Cl⁻ is similar in size to S²⁻, it has one charge instead of two and has substantially different bonding and reactivity properties. Other substitutions may be made, for example, in some cases, some of the S²⁻ can be substituted with a halogen (e.g., Cl⁻) and the rest replaced with Se²⁻. Similarly, various substitutions may be made for the GeS₄³⁻ sites. PS₄³⁻ may replace GeS₄³⁻; also PO₄³⁻, PSe₄³⁻, SiS₄³⁻, etc. These are all tetrahedral ions with four chalcogen atoms, overall larger than S²⁻, and triply or quadruply charged.

In other examples, which will be compared to the Li₆PS₅Cl argyrodite structure described above, Li₆PS₅Br and Li₆PS₅I substitute larger halides in place of the chloride, e.g., Li₆PO₅Cl and Li₆PO₅Br. Z. anorg. Allg. Chem., 2010, no. 636, 1920-1924, incorporated by reference herein for the purpose of describing certain argyrodites, contain the halide substitutions described as well as exchanging every sulfur atom in the structure, in both the S²⁻ and PS₄³⁻ ions, for oxygen. The phosphorus atoms in the PS₄³⁻ ions found in most examples of lithium-containing argyrodites can also be partially or wholly substituted, for instance the series Li₇₊ₓMₓP₁₋ₓS₆ (M=Si, Ge) forms argyrodite structures over a wide range of x. See J. Mater. Chem. A, 2019, no. 7, 2717-2722, incorporated by reference herein for the purpose of describing certain argyrodites. Substitution for P can also be made while incorporating halogens. For example, Li₆₊ₓSiₓP₁₋ₓS₅Br is stable from x=0 to about 0.5. See J. Mater. Chem. A, 2017, no. 6, 645-651, incorporated by reference herein for the purpose of describing certain argyrodites. Compounds in the series Li₇₊ₓMₓSb₁₋ₓS₆ (M=Si, Ge, Sn), where a mixture of SbS₄³⁻ and MS₄⁴⁻ are substituted in place of PS₄³⁻ and I⁻ is used in place of Cl⁻, have been prepared and found to form the argyrodite structure. See J. Am. Chem. Soc., 2019, no. 141, 19002-19013, incorporated by reference herein for the purpose of describing certain argyrodites. Other cations besides lithium (or silver) can also be substituted into the cation sites. Cu₆PS₅Cl, Cu₆PS₅Br, Cu₆PS₅I, Cu₆AsS₅Br, Cu₆AsS₅I, Cu_{7.82}SiS_{5.82}Br_{0.18}, Cu₇SiS₅I, Cu_{7.49}SiS_{5.49}I_{0.51}, Cu_{7.44}SiSe_{5.44}I_{0.56}, Cu_{7.75}GeS_{5.75}Br_{0.25}, Cu₇GeS₅I and Cu_{7.52}GeSe_{5.52}I_{0.48} have all been synthesized and have argyrodite crystal structures. See Z. Kristallogr, 2005, no. 220, 281-294, incorporated by reference herein for the purpose of describing certain argyrodites. From the list of examples, it can be seen that not only can single elements be substituted in any of the various parts of the argyrodite structure, but combinations of substitutions also often yield argyrodite structures. These include argyrodites described in US Patent Publication No. 20170352916 which include Li_{7-x+y}PS₆₋ₓCl_{x+y} where x and y satisfy the formula 0.05≤y≤0.9 and −3.0x+1.8≤y≤−3.0x+5.7.

Argyrodites may be synthesized from precursors, which are also referred to as reagents. To make Li₆PS₅Cl, for example, LiCl, Li₂S, and P₂S₅, are reacted. Argyrodites may be synthesized using one of three main synthetic methods: high energy ball-milling (mechanochemical synthesis), thermal synthesis, and solution synthesis.

High energy ball-milling applies mechanical energy to induce a chemical reaction between argyrodite precursors and forms a highly amorphous particle. An additional annealing step can be used to increase crystallinity, and thus conductivity, of the highly amorphous ball-milled argyrodite. This approach has a long processing time with multiple steps. For example, an initial milling may be 60 hours, with midpoint and endpoint scrapes of the material from the milling cup walls, sieving, annealing for 20 hours, sieving, lower energy milling for particle size reduction, and sieving again. The approach also has poor energy efficiency with the processed powders typically less than 1% of the total weight of the materials that are accelerated at high speeds. Standard milling equipment is configured for short processing times and can experience wear during the long reaction time.

In thermal synthesis, reagents are thermally reacted at high temperature to form argyrodite phase. Unlike ball-milling, solid-state reactions are run at high temperatures that are similar to annealing temperatures, thus providing highly crystalline materials. For argyrodites, this may be not a pure solid-state reaction as one of the reagents may melt below the reaction temperature. P₂S₅, for example, melts below the reaction temperature. Elemental sulfur can also be added to the reaction mixture for sulfidic argyrodites. It melts, then vaporizes as the mixture is heated to the reaction temperature. In some cases, the precursors can be pre-milled before the thermal reaction. Ibis shortens reaction time, but adds extra steps and equipment. After reaction, a solid monolith is obtained that may then be milled several times to obtain a useful particle size. While reaction times are shorter than mechanochemical synthesis, the method involves several pre- and post-reaction milling operations. Energy efficiency is also low as a significant fraction of the energy heats the processing vessel. The reaction itself is highly corrosive to most metals, which limits the processing vessel design and/or lifetime.

In solution synthesis, reactants are mixed in an argyrodite solvent that enables full or partial dissolution or reagents and/or the products. The solvent is carefully selected as certain functional groups such as alcohols react to form unwanted byproducts while low polarity solvents, such as toluene and unfunctionalized hydrocarbons, give no reaction at all. The reagents are only slightly soluble in the best solvents and so the reaction is likely proceeds at the interface of the solvent and the suspended particles. The reaction therefore proceeds more quickly when the precursor materials have been milled to small particle sizes. After the reaction is complete the bulk of the solvent can be removed by filtering off the product, with residual solvent removed by heat. The product, only partially crystalline at this stage, is annealed at high temperature and miled to an appropriate size. There are many time-consuming steps in solution synthesis. The process is also energy inefficient with the solvent heated with the reagent. Solvent may be recovered but must be purified before re-use. Finally, the argyrodites synthesized from solution synthesis have lower conductivity than those synthesized by mechanochemical or thermal methods.

Described herein are methods of exposing particles to microwave energy while milling them. The methods reduce or eliminate the need for pre- and post-processing of reagents and products while minimizing waste associated with the slow kinetics of heat transfer in traditional resistive heating furnaces.

In some embodiments, a microwave susceptible media is used is for heat transfer through the reaction volume. The media have a much larger surface area than the processing vessel itself. This is advantageous as heat transfer occurs mostly through direct contact between a susceptor and particle surfaces. The media and the reagent powders are in constant motion. Averaged over short periods of time (e.g., seconds or less) all of the reagents will be evenly exposed to heated media surfaces. The media moves through the microwave field, mitigating any non-uniformity in the field itself.

### Apparatus

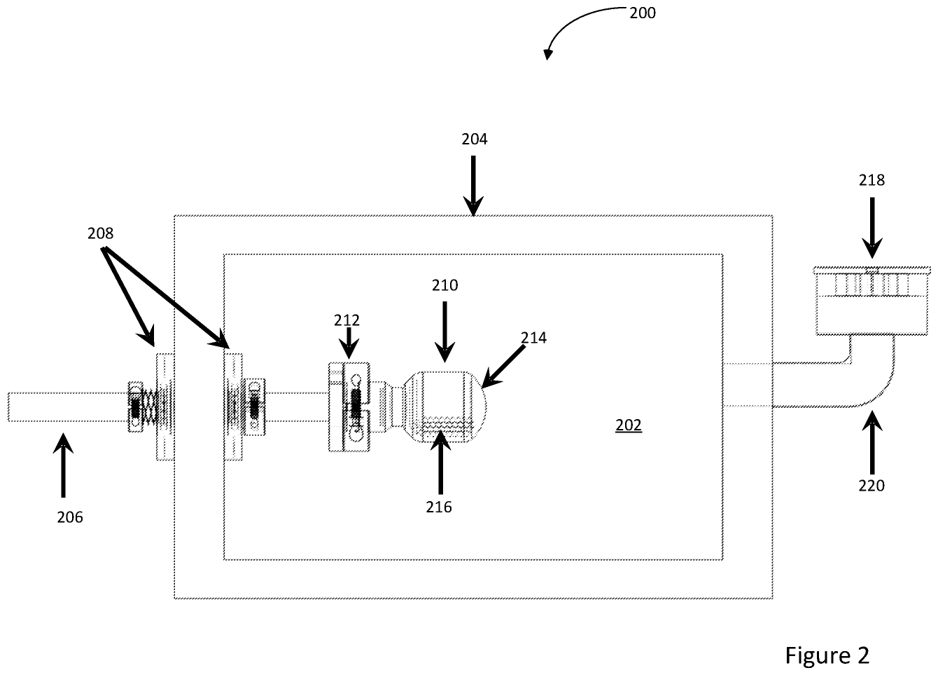

FIG. 2 shows an example of an apparatus 200 configured to perform methods as described herein. The apparatus 200 includes a microwave enclosure 202 defined by a housing 204. A rotation shaft 206 is coupled or configured to be coupled to a motor (not shown) and extends through the housing 204. The rotation shaft 206 is supported at the pass-through by pass-through supports 208, which include bearings for free rotation.

Inside the microwave enclosure 202, a processing vessel 210 is attached to the rotation shaft 206. In the example of FIG. 2, a clamp 212 attaches the processing vessel 210 to the rotation shaft 206. The processing vessel 210 is rotatably coupled to the rotation shaft 206, such that as the rotation shaft 206 rotates, the processing vessel rotates.

The processing vessel may be sealed with a cap 214. Milling/susceptor media 216 and reagents are housed within the processing vessel 210. A microwave generator, including a magnetron 218 and microwave waveguide 220, generates and directs microwave energy to the microwave enclosure 202.

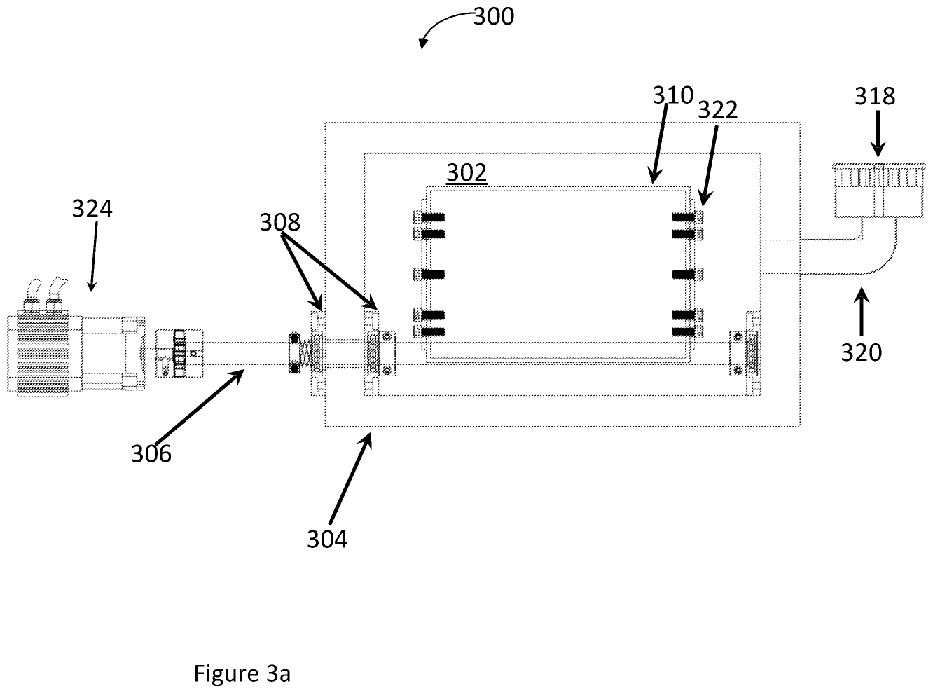

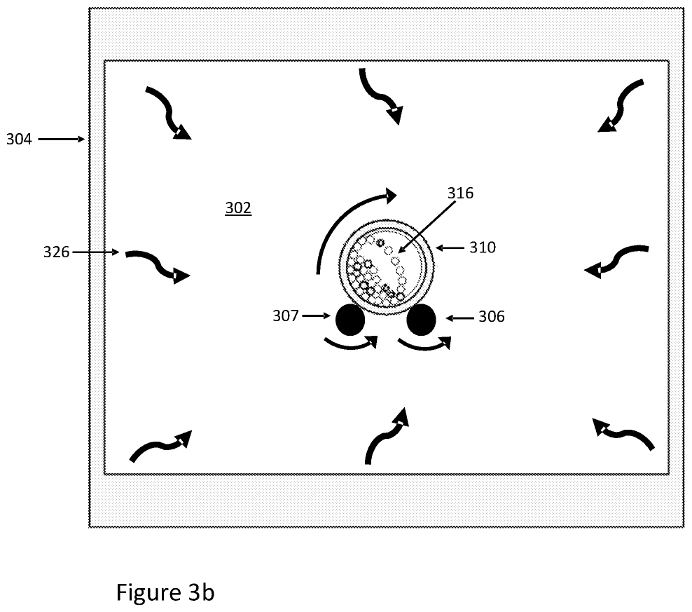

FIG. 3A shows another example of an apparatus 300 configured to perform methods as described herein. The apparatus 300 is similar to apparatus 200 described above with reference to FIG. 2. It includes a microwave enclosure 302 defined by a housing 304. A rotation shaft 306 is configured to be coupled (directly or indirectly) to a motor 324 and extends through the housing 304. The rotation shaft 306 is supported at the housing pass-through by pass-through supports 308, which include bearings for free rotation. Inside the microwave enclosure 302 is a processing vessel 310, including two caps that are attached by bolts 322. Milling/susceptor media (not shown) may be in the processing vessel 310. Also like in FIG. 2, a microwave generator, including a magnetron 318 and microwave waveguide 320, generates and direct microwave energy to the microwave enclosure 302.

The processing vessel 310 rests on and is supported by the rotation shaft 306 and a second free-spinning shaft (not pictured). The processing vessel is cylindrical and rotatably coupled to the rotation shaft 306, such that as the rotation shaft 306 rotates, the processing vessel rotates.

FIG. 3B shows a cross-sectional view of the apparatus 300 in operation. (Note that the relative dimensions of the components differ in FIGS. 3A and 3B for ease of illustration). The processing vessel 310 contains milling/susceptor media 316 along with reagents. The rotation shaft 306 is powered and rotates in the indicated direction. The rotation shaft 306 and second passive (unpowered) rotation shaft 307 support the processing vessel 310, which rotatably coupled to the rotation shaft 306. As the processing vessel 310 rotates in the indicated direction, the media falls for milling and absorbs microwave energy 326 to heat the reagents.

While examples of roller milling are given above, other types of milling may be used including vibratory milling and disc milling. Roller milling is more energy efficient than disc milling and may be advantageous. Each milling mechanism will generally include a coupling from the processing vessel to a motor outside the microwave enclosure.

The processing vessel is made of a material that can withstand the reaction temperature. The material may be microwave transparent or a microwave susceptor. In certain embodiments, the material is microwave transparent to allow most of microwave energy to be absorbed by the susceptor media. A microwave susceptor may be used for rapid heating, or for heating without susceptor media. Examples of microwave transparent materials include glass and plastics. Examples of microwave susceptor materials include silicon carbide (SiC), tungsten carbide (WC), and silicon nitride (SiN). Monitoring of the reaction, e.g., by visual inspection or a quantitative technique such as Raman spectroscopy may be aided by an optically transparent material such as glass.

Any appropriate shape of vessel may be employed. In the examples of FIGS. 2-3B, the vessel is cylindrical for a roller mill process. Other shapes (e.g., spherical or partially spherical) may be used as appropriate for milling. In some embodiments, the apparatus is configured to be used with different sizes of processing vessels. For example, the total volume and length:diameter ratio of a cylindrical processing vessel can be important parameters for a particular reaction. Cylindrical processing vessels of different sizes may be attached to and/or supported by a rotation shaft.

For some applications, the processing vessel is hermetic and includes a seal. In the example of FIG. 2, the processing vessel is capped with a polytetrafluoroethylene (PTFE) cap and sealed with a Viton O-ring. In argyrodite synthesis, for example, the reagents and product are highly sensitive to moisture. The processing vessel is loaded under strictly anhydrous conditions and remains sealed throughout the reaction. A sealed processing vessel also prevents vapor from escaping. For processing of sulfidic materials, it can be important to prevent sulfur vapor from escaping. For some embodiments, the processing vessel may be unsealed and/or vented to allow escape of products such as water vapor.

The maximum processing temperature may be determined by the maximum temperatures of the component parts of the processing vessel. While a material that is able to withstand high temperatures, such as glass, may be used for the main body of the processing vessel, other components such as a cap, bolts or other attachment mechanism, and seal may be made of a material that melts or degrades at lower temperatures. Examples of materials for these components include polyether ether ketone (PEEK). In some embodiments, a cap and/or an attachment mechanism may be made of a temperature resistant material such as glass. The sealing material, being removable, is may be a material such as an elastomer. In some embodiments, materials with low temperature resistance may be thermally insulated from any material that is a microwave susceptor or is in contact with one. This can allow processing temperatures that are higher than the maximum allowable temperature of the low resistance material.

In some embodiments, instead of a microwave generator, another energy generator may be used. Example frequencies include 300 MHz to 300 GHz for microwave generators. Home microwaves are tuned to 2.45 (GHz), the peak adsorption frequency of liquid water, and couple to the susceptors described herein. Other frequencies also couple to these susceptors to produce heat. Energy at 1 MHz to 300 MHz can also heat conductive and magnetic materials and may be used. Any appropriate high frequency electromagnetic wave generator, including but not limited to magnetrons, power grid tubes, klystrons, klytrodes, crossed-field amplifiers, traveling wave tubes and gyrotrons, may be used.

The media may be chosen for a particular application and may have two purposes: milling media to reduce particle size and susceptor media to heat the particles. According to various embodiments, the same or different materials may be used for these purposes. The media is also selected for chemical stability and inertness with respect to the reagents.

There are several interaction types that materials can have with microwaves.
They can absorb microwaves and transfer energy (e.g., by heating the material).
They can be transparent, allowing all or most of the microwave energy to pass through the material.
They can reflect microwaves.

Most materials have at least a little of each of these characteristics. For the purposes of the methods and apparatuses described herein, microwave susceptors absorb microwaves and produce heat to an extent that can do useful work such as drive a chemical reaction ora phase change. Microwave transparent materials absorb little microwave energy and do not heat, or heat only to the extent that heating is insufficient to cause chemical reactions or mechanical deformations in the system that would change the practical function of any part of the system.

Examples of susceptor media include silicon carbide (SiC), silicon nitride (SiN), and tungsten carbide (WC). In some embodiments, these materials are appropriately sized for milling. For example, 5 mm SiC spheres have been used for argyrodite synthesis. Susceptor media like SiC may also be used with a separate microwaver inert milling media, e.g., zirconia, agate, and alumina. In such cases, the susceptor media may be less dense such that it does not mill, but transmits heat to the particles.

In some embodiments, the reagents may be microwave susceptors and/or the body of the processing vessel may be a microwave susceptor such that only microwave transparent milling media is used.

### Methods

According to various embodiments, microwave milling may be used for one or more of the following:
Reaction of non-microwave adsorbing solid reagents. Susceptor media heats and transfers energy to reagents. Milling media and the roller milling action breaks down large to provide higher surface area for heat transfer from media and interaction with other reagents. As described above, the susceptor media and the milling media may be the same or different. The roller milling action may provide continuous mixing. In some embodiments, the roller milling may also be used to obtain small product particles, simplifying further processing.
Reaction of microwave adsorbing solid reagents. Susceptor media may or may not be used. Milling media (susceptor or microwave transparent) reduces the particle size reagents and products and provides continuous mixing. Microwave energy is transferred directly to one or more reagents, and also to media if susceptor media is used.
Annealing of material that does not strongly absorb microwaves. Susceptor media heats the material to be annealed. Simultaneously, milling media (same or different as susceptor media) grinds to control particle size. Annealing the material may induce a phase change, e.g., to a partially crystalline or crystalline material.
Annealing of microwave adsorbing materials. Susceptor media may or may not be used. Milling media (susceptor or microwave transparent) reduces the particle size reagents and products and provides continuous mixing. Microwave energy is transferred directly to one or more reagents, and also to media if susceptor media is used. Milling action controls particle size while annealing and/or crystallizing (or inducing another phase change in) the material via microwave heating, simplifying further processing.

In some embodiments, argyrodites are synthesized. For example, Li₂S, LiCl, P₂S₅ and elemental sulfur may be reacted to form Li₆PS₅Cl. Precursor powders (reagents) are mixed, milled, and heated by the rotating action of the vessel and the tumbling media, which adsorbs microwaves and transfers that energy to the reagents in the form of heat. As the reagents heat, the P₂S₅ melts and rapidly reacts with Li₂S to form Li₃PS₄. This intermediate has some moderate ionic conductivity and is therefore a microwave susceptor itself. It begins to heat under microwave power and begins to incorporate further Li₂S and LiCl to form Li₆PS₅Cl argyrodite. The argyrodite is also a microwave susceptor and will heat directly from interaction with microwaves. This direct heating allows argyrodite particles to heat quickly through their entire volume to a temperature which allows crystallite grains to grow larger and amorphous regions of the material to crystallize. Other formulations that crystallize in the argyrodite structure can also be formed in the manner described. The processing temperature may be less than used in a non-microwave (e.g., resistive heating) thermal process. For example, argyrodite synthesis as described herein may be performed at less than 300° C. or less than 250° C. in some embodiments.

In some embodiments, other sulfide-containing solid electrolytes are synthesized. A sulfide containing particle is provided. For example, for lithium-ion conducting sulfide glass particles, lithium sulfide (Li₂S) is provided. Another component of the glass that is provided as a raw material may include at least one of phosphorous (P), germanium (Ge), aluminum (Al), silicon (Si) and boron (B). For example, phosphorus pentasulfide (P₂S₅) may be provided with Li₂S to form Li₂S—P₂S₅-based glass particles. Li₂S—P₂S₅ systems, for example, are useful in many applications for their relatively high ionic conductivities. However, other components that may be provided include phosphorous trisulfide (P₂S₃), boron sulfide (B₂S₃), and silicon disulfide (SiS₂). In some embodiments, the glasses are sodium-ion conducting sulfide glass particles, with example precuresors to be provided include sodium-containing compounds. The precursors may be provided as powders.

One or more conductive dopants and additives may be also be provided. Dopants that enhance ionic conductivity include lithium halides such as lithium iodide (LiI), lithium borohydride (LiBH₄), and lithium ortho-oxosalts (Li₃PO₄). In some embodiments, one or more additives that do one or more of reducing particle size, reducing particle size distribution, and facilitating dispersion in a solution are added. Examples of additives are described in U.S. Pat. No. 11,264,639, incorporated by reference herein.

In some embodiments, a thiophilic metal dopant is added. Examples include manganese (Mn), iron (Fe), cobalt (Co), nickel (Ni), copper (Cu), zinc (Zn), mercury (Hg), molybdenum (Mo), and combinations thereof.

According to various embodiments, the ratio of thiophilic metal atoms to sulfur atoms in the alkali metal sulfide-based ion conductor is at least 1:120. In some embodiments, the ratio of thiophilic metal atoms to sulfur atoms in the alkali metal sulfide-based ion conductor is at least 1:50.

In some embodiments, the ratio of thiophilic metal atoms to sulfur atoms in the alkali metal sulfide-based ion conductor is no more than 1:1. In some embodiments, the ratio of thiophilic metal atoms to sulfur atoms in the alkali metal sulfide-based ion conductor is no more than 1:4.

In some embodiments, the alkali metal is one of lithium (Li), sodium (Na) or potassium (K). In some embodiments, the alkali metal is lithium. In some embodiments, the alkali metal argyrodite sulfide-based ion conductor is given by the formula:

A_{7-x-(z*y)}M^{z}_{y}PS^{6-x}Halₓ
wherein
A is the alkali metal;
M is the thiophilic metal;
Hal is selected from chlorine (Cl), bromine (Br), and iodine (I);
z is the oxidation state of the metal;
0<x≤2; and
0<y<(7−x)/z.

In some embodiments, z>+1. In some embodiments, z=+2. In some embodiments, 1≤x≤1.6. In some embodiments, 0.1≤y≤2−x. In some embodiments, alkali metal argyrodite sulfide-based ion conductor is given by the formula: A_{7-x+n-(z*y)}M^{z}_{y}PS₆₋ₓHalₓ₊ₙ
wherein
A is the alkali metal;
M is the thiophilic metal;
Hal is selected from chlorine (Cl), bromine (Br), and iodine (I);
z is the oxidation state of the metal;
0.05≤n≤0.9
3.0x+1.8≤n≤−3.0x+5.7
0≤y<(7−x)/z; and
0<x≤2.

In some embodiments, z>+1. In some embodiments, z=+2. In some embodiments, the ratio of thiophilic metal atoms to sulfur atoms in the alkali metal argyrodite sulfide-based ion conductor is at least 1:120. In some embodiments, the ratio of thiophilic metal atoms to sulfur atoms in the alkali metal argyrodite sulfide-based ion conductor is at least 1:50. A thiophilic metal-containing material such as a metal sulfide (e.g., CuS) may be added to the process vessel.

Examples of other materials that may be synthesized include cathode active material NMC (lithium nickel manganese cobalt oxide) using lithium acetate dehydrate, nickel (II) acetate tetrahydrate, manganese(II) acetate tetrahydrate and cobalt(II) acetate tetrahydrate reagents with a chelating agent such as citric acid and polyvinyl pyrrolidone (PVP). These materials would be mixed/milled and then heated to 350° C. with milling continuing. A calcination operation may then be performed. In some embodiments, this operation may be done at high temperatures (e.g., 900° C.) in a high temperature vessel with or without microwave exposure. In some embodiments, it may be performed at lower temperatures in the same vessel. This reaction does not need to be sealed off from the atmosphere, so we can materials such as plastics and elastomers that can limit the operating temperature may be omitted, allowing a higher operating temperature than for argyrodite synthesis.

The following parameters may be varied to control the reaction rate, extent of reaction, phase change rate, extent of phase change, particle size, and product quality.
Microwave power: Any appropriate power may be used with larger powers used for larger sample sizes. For lab-scale samples (e.g., up to 100 g), examples powers may be 5 W to 2 kW. For larger samples (e.g., 100 kg), increase power may be used. In some embodiments, the power may be varied during the process. For example, power may be decreased in applications in which the system becomes more efficient at converting the microwave energy to heat. This includes syntheses in which the product is a microwave susceptor. In some embodiments, the microwave power may be turned off while milling continues to further reduce particle size after the reaction is complete. In some embodiments, the microwave power may be paused or otherwise varied throughout the process.
Total loading of reagents with respect to the volume of the processing vessel.
Total loading of media with respect to volume of the processing vessel.
Media:reagent ratio. The loading and ratio parameters can be optimized to achieve a small particle size efficiently. In one example, about 50% of the volume is filled with media an 25% with powder to be milled for dry milling. These can be increased or decreased appropriately such that falling media impacts the powder to be milled rather other media or vessel walls.
Processing vessel materials (main body, cap, attachment features (e.g., bolts or screws), seal). These can include microwave susceptor and/or microwave transparent materials as discussed above.
Media materials. Milling media can be microwave susceptor or microwave transparent. Susceptor media may or may not be used as milling media. In some embodiments, it may be useful to use microwave susceptible milling media. For example, for increased heat transfer, it may be useful to have microwave susceptible media appropriately sized for high contact with the particles. In other embodiments, it may be useful to decouple milling and heat transfer functions.
Diameter and shape of media. In addition to spheres, other shapes may be used. In some embodiments, mixed sizes and shapes may be used. Generally smaller media will produce smaller particles in a mill, but small media may not be able to break up larger particles. To achieve very small particles from relatively large particles in a single run, mixed sized media (e.g., 10 mm and 3 mm media) may be used.
Media density: Media density can be used to control milling, and in some embodiments, whether the susceptor media is milling or not.
Rotation speed: The rotation speed for maximum milling efficiency is largely determined by the vessel radius along with the radius of the milling media. In some embodiments, it may be useful to operate at less than maximum milling efficiency by appropriately controlling the speed.
Microwave cavities: Single or multimode microwave cavities may be employed. In some embodiments, a single mode cavity where all of the energy is focused in a small area including the processing vessel may be used. However, because the susceptor media can move throughout the vessel, it can mitigate non-uniformity in consumer-type microwave ovens.
Closed or open processing vessel: The processing vessel may be closed (e.g., to prevent moisture from entering, sulfur vapor from leaving, etc.) or open (e.g., to allow gaseous products to escape, or flow a gas such as O₂ or H₂ into the vessel during processing). In some embodiments, the vessel is closed with a pressure safety release.
Environmental conditions: for some embodiments, the atmosphere in the processing vessel is important to the reaction. Gaseous atmosphere may be introduced prior to sealing the processing vessel or during processing (e.g., by flowing a gas into the microwave enclosure and open processing vessel). In some embodiments, a liquid can be in the processing vessel. A liquid may be used as one or more of: a milling aid, a reagent, heat transfer medium between materials in the processing vessel, or to directly adsorb microwave energy. A liquid may completely fill the volume of the processing vessel not occupied by solid materials, or it may fill part of the volume and leave some space for a gaseous atmosphere. In some embodiments, no liquid is present, with the processing dry other than molten reagents.
Solvent: In many embodiments, the processing is solvent-free. However, a solvent may be used in some cases. Similarly, in many embodiments, the reagents are not suspended in a liquid, though a suspension may be used in some cases.

The foregoing describes the instant invention and its certain embodiments. Numerous modifications and variations in the practice of this invention are expected to occur to those skilled in the art. For example, while the above specification describes synthesis of inorganic electrolytes, the microwave milling may be used for other particulate compositions. Further, various modifications may be made the arrangement of components in the apparatus. Such modifications and variations are encompassed within the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method comprising:
providing a processing vessel containing particles to be processed and milling media; and
simultaneously a) moving the processing vessel to cause interactions between the particles and the milling media to thereby reduce the size of the particles and b) exposing the processing vessel to microwave radiation.

17. The method of claim 16, wherein the milling media is a microwave susceptor.

18. The method of claim 16, where in the milling media is microwave transparent.

19. The method of claim 18, wherein the processing vessel contains microwave susceptor media.

20. The method of claim 16, wherein the particles to be processed comprise argyrodite precursors.

21. A method comprising:
providing argyrodite precursor particles, microwave susceptor media, and milling media in a reaction vessel;
simultaneously rotating the reaction vessel while exposing the reaction vessel to microwaves to thereby heat the microwave susceptor media and reduce the size of the argyrodite precursor particles;
heating the argyrodite precursor particles by contact with the microwave susceptor media;
reacting the argyrodite precursor particles to form argyrodite particles; and
reducing the size of the argyrodite particles.

22. The method of claim 21, wherein the argyrodite precursor particles comprise LiX, Li₂S, and P₂S₅, wherein X is a halogen.

23. The method of claim 22, where in the argyrodite precursor particles further comprise elemental sulfur.

24. The method of claim 21, wherein the microwave susceptor media are the milling media.

25. The method of claim 21, wherein the microwave susceptor media and the milling media are different media.

26. The method of claim 21, further comprising reducing microwave power as more argyrodite particles are formed.

27. The method of claim 21, further comprising ending the microwave exposure and continuing to rotate the reaction vessel to further reduce argyrodite particle size.

28. A method comprising:
providing precursor particles of a sulfide-containing solid electrolyte, microwave susceptor media, and milling media in a reaction vessel;
simultaneously rotating the reaction vessel while exposing the reaction vessel to microwaves to thereby heat the microwave susceptor media and reduce the size of the precursor particles;
heating the precursor particles by contact with the microwave susceptor media;
reacting the precursor particles to form sulfide-containing solid electrolyte particles.

29. The method of claim 28, further comprising reducing the size of the particles.
